(19) United States
(12) Patent Application Publication
(10) Pub. No.: US 2020/0254843 A1
(43) Pub. Date: Aug. 13, 2020

(54) AXLE/SUSPENSION SYSTEM FOR HEAVY-DUTY VEHICLES

(71) Applicant: Hendrickson USA, L.L.C., Itasca, IL (US)

(72) Inventors: R. Scott Fulton, Hudson, OH (US); Damon Delorenzis, Plainfield, IL (US)

(21) Appl. No.: 16/779,705

(22) Filed: Feb. 3, 2020

Related U.S. Application Data
(60) Provisional application No. 62/802,747, filed on Feb. 8, 2019.

(51) Int. Cl. B60G 17/015; B60G 11/27; B60G 17/0165; B60G 17/052

(52) U.S. Cl. CPC B60G 17/0155; B60G 11/27; B60G 17/0165; B60G 17/0523; B60G 2202/152; B60G 2400/204; B60G 2300/026; B60G 2204/111; B60G 2204/126

(57) ABSTRACT

An axle/suspension system for a heavy-duty vehicle including a wheel and a sensor. The sensor is operatively connected to an air spring mounted on the axle/suspension system and is capable of detecting a condition of a road or the heavy-duty vehicle. The air spring has a stiffness capable of being altered in response to the sensor and to reduce resonant load variation on the wheel.

### CROSS-REFERENCE TO RELATED APPLICATION

This application claims the benefit of U.S. Provisional Patent Application No. 62/802,747, filed Feb. 8, 2019.

### BACKGROUND OF THE INVENTION

### Field of the Invention

The present invention relates generally to the art of axle/suspension systems for heavy-duty vehicles. In particular, the present invention relates to heavy-duty vehicle axle/suspension systems that react forces imparted on the axle/suspension system during operation of the heavy-duty vehicle. More particularly, the present invention is directed to an axle/suspension system for a heavy-duty vehicle that exhibits no natural frequency or has a variable, or adjustable, natural frequency during operation of the heavy-duty vehicle to reduce irregular or excessive tire wear and increase the durability of the axle/suspension system and its component parts.

### Background Art

The use of one or more air-ride axle/suspension systems has been popular in the heavy-duty vehicle industry. For the purposes of clarity and convenience, reference is made to a heavy-duty vehicle with the understanding that such reference includes trucks, tractor-trailers and semi-trailers, trailers, and the like. Some heavy-duty vehicle axle/suspension systems are designed and built in anticipation of particular environments, do not actively respond to environmental changes, and must be reconfigured mechanically when such environmental changes are encountered. Generally, such passive axle/suspension systems are designed to provide a specific balance, chosen in advance, between ride comfort and handling/stability of the heavy-duty vehicle. Although such passive axle/suspension systems can be found in widely varying structural forms, in general their structure is similar in that each system typically includes a pair of suspension assemblies. The suspension assemblies are typically connected directly to the primary frame of the heavy-duty vehicle or to a subframe supported by the primary frame. For those heavy-duty vehicles that support a subframe, the subframe can be non-movable or movable, the latter being commonly referred to as a slider box, slider subframe, slider undercarriage, secondary slider frame, or bogey.

Each suspension assembly of an axle/suspension system typically includes a longitudinally extending elongated beam. Each beam is typically located adjacent to and below a respective one of a pair of spaced-apart longitudinally extending main members and one or more cross members, which form the frame of the heavy-duty vehicle. For the purpose of convenience and clarity, reference herein will be made to main members, with the understanding that such reference is by way of example, and includes main members of primary frames, movable subframes, and non-movable subframes. Each beam is pivotally connected at one of its ends to a hanger, which in turn is attached to and depends from a respective one of the main members of the heavy-duty vehicle. The beam may extend rearwardly or frontwardly from the pivotal connection relative to the front of the heavy-duty vehicle, thus defining what are typically referred to as trailing- or leading-arm axle/suspension systems, respectively. An axle extends transversely between, and is typically connected by some means to, the beams of the suspension assemblies at a selected location from about the mid-point of each beam to the end of the beam opposite the pivotal connection end. An air spring, or its equivalent, and/or, optionally, a shock absorber for providing damping are operatively connected to, and extend between, a respective one of the main members and suspension assemblies. A height control valve may be mounted on the main member or other support structure and operatively connected to the beam and to the air spring in order to maintain the ride height of the heavy-duty vehicle. A brake system is also mounted on the axle/suspension system.

The axle/suspension systems of the heavy-duty vehicle act to cushion the ride, damp vibrations, and stabilize the heavy-duty vehicle during operation. In particular, as the heavy-duty vehicle is traveling over the road, the wheels of the heavy-duty vehicle encounter road conditions that impart various forces, loads, and/or stresses, collectively referred to herein as forces, to the respective axle on which the wheels are mounted, and in turn, to the suspension assemblies that are connected to and support the axle. These forces include vertical forces caused by vertical movement of the wheels as they encounter certain road conditions, fore-aft forces caused by acceleration and deceleration of the heavy-duty vehicle, and side-load and torsional forces associated with transverse heavy-duty vehicle movement, such as turning and lane-change maneuvers.

In order to minimize the detrimental effect of these forces on the heavy-duty vehicle during operation, the axle/suspension system is designed to react and/or absorb at least some of them. In particular, the axle/suspension systems have differing structural requirements to address these disparate forces. More particularly, it is desirable for an axle/suspension system to be fairly stiff in order to minimize the amount of sway experienced by the heavy-duty vehicle and thus provide what is known in the art as roll stability. However, it is also desirable for an axle/suspension system to be relatively flexible to assist in cushioning the heavy-duty vehicle from vertical impacts and to provide compliance to resist failure and increase the durability of the components of the axle/suspension system. It is also desirable to damp the vibrations or oscillations that result from forces acting on the axle/suspension system to provide a more comfortable ride and reduce irregular or excessive wear of the tires.

Due to the static nature of passive axle/suspension systems, the axle/suspension system typically cannot alter operational characteristics in the event a modification in handling or ride comfort become necessary due to sudden environmental changes. Moreover, passive axle/suspension systems have associated natural frequencies that can potentially lead to development or propagation of resonant vibrations in and through the axle/suspension system. Such natural frequencies exhibited by the axle/suspension system can lead to tire resonant load variation, which may result in irregular and/or excessive tire wear. This increased or irregular tire wear may potentially result in increased tire maintenance and associated costs and/or reduced road safety due to uneven tire traction or increased potential for tire failure.

The use of semi-active and active axle/suspension systems has been known in passenger vehicles and has become increasingly popular due to the improved ride and handling characteristics achievable with recent advancements in control systems. Unlike passive axle/suspension systems which do not change their characteristics based on various factors, such as heavy-duty vehicle load and road conditions, semi-active and active axle/suspension systems are designed to dynamically alter suspension characteristics as environmental variables and heavy-duty vehicle parameters change. This allows the suspension to automatically adjust characteristics that may result in increased handling or ride comfort as the situation may require. As a result, the semi-active and active axle/suspension systems may exhibit a dynamically changing natural frequency, which prevents development and propagation of resonant vibrations, reducing or preventing irregular and/or excessive tire wear, thereby reducing maintenance and associated costs and increasing safety.

Prior art semi-active axle/suspension systems are similar in structure to prior art passive axle/suspension systems and often use typical components such as air springs and shock absorbers. However, the air springs and/or shock absorbers of semi-active axle/suspension systems are specialized, providing adjustable mechanisms that allow force output control within a bounded range and allow dynamic changes to be made to the axle/suspension system in order to alter certain operational characteristics of the axle/suspension system.

Prior art active axle/suspension systems are also similar in structure to prior art passive axle/suspension systems and prior art semi-active axle/suspension systems. However, prior art active axle/suspension systems typically exert axial forces directly on suspension components in order to counter the forces acting on the axle/suspension system, thereby minimizing and counteracting transmission of such forces to the main members of the heavy-duty vehicle. In active axle/suspension systems, the typical air spring and shock absorber are replaced by a linear actuator with a coiled spring connected to and arranged about the actuator. The actuators are connected between a respective main member and suspension assembly of the axle/suspension system. The actuators are generally hydraulically/pneumatically or magnetically driven. More specifically, hydraulic/pneumatic actuators generally are operatively connected to a pump and a reservoir, which act in concert to alter fluid or air pressure gradients within the linear actuator to drive actuator action.

Prior art passive, semi-active, and active axle/suspension systems, while adequately absorbing and or reacting forces, have potential disadvantages, drawbacks, and limitations. For example, prior art semi-active and active axle/suspension systems and passive axle/suspension systems requiring shock absorbers are relatively heavy, reducing the amount of cargo that can be carried by the heavy-duty vehicle. Prior art passive axle/suspension system shock absorbers and the components of prior art semi-active and active axle/suspension systems also add complexity to the prior art axle/suspension systems. Moreover, the shock absorbers, linear actuators, and hydraulic/pneumatic components of the prior art axle/suspension systems are service items that require maintenance and/or replacement from time to time, adding additional maintenance and/or replacement costs for the axle/suspension system.

The present invention overcomes the disadvantages, drawbacks, and limitations associated with prior art passive, semi-active, and active axle/suspension systems by providing an axle/suspension system that does not exhibit a natural frequency or that has an adjustable, variable, or modifiable natural frequency, eliminating the need for heavy and more complex components that require higher maintenance and/or replacement costs, while preventing development and propagation of harmonic vibration through the axle/suspension system of the heavy-duty vehicle during operation, thereby reducing irregular or excessive tire wear and increasing durability and safety of the axle/suspension system and its component parts.

### SUMMARY OF THE INVENTION

Objectives of the present invention include providing an axle/suspension system that does not exhibit a natural frequency or that has an adjustable, variable, or modifiable natural frequency.

A further objective of the present invention is to provide an axle/suspension system that prevents development and propagation of harmonic vibrations through the axle/suspension system.

Yet another objective of the present invention is to provide an axle/suspension system that reduces irregular or excessive tire wear and promotes durability and safety of the axle/suspension system and its component parts.

Another objective of the present invention is to eliminate the need for complex and heavy components that require higher maintenance and/or replacement costs.

These objectives and advantages are obtained by the axle/suspension system for a heavy-duty vehicle, according to the present invention, having a wheel and a sensor. The sensor is operatively connected to an air spring and is capable of detecting a condition of a road or of the heavy-duty vehicle. The air spring is mounted on the axle/suspension system and has a stiffness that is altered in response to the sensor to reduce resonant load variation on the wheel.

### BRIEF DESCRIPTION OF THE SEVERAL VIEWS OF THE DRAWINGS

The preferred embodiments of the present invention, illustrative of the best mode in which Applicant has contemplated applying the principles, is set forth in the following description, shown in the drawings, and particularly and distinctly pointed out and set forth in the appended claims.

FIG. 1 is a top rear perspective view of a prior art passive axle/suspension system incorporating a pair of shock absorbers and a pair of air springs mounted on respective suspension assemblies of the axle/suspension system;

FIG. 2 is a fragmentary schematic elevational view of a first exemplary embodiment axle/suspension system, according to the present invention, showing a reservoir operatively fluidly connected via a valve to an air spring mounted between the frame and one of the pair of suspension assemblies of the axle/suspension system;

FIG. 3 is a perspective view in section of the air spring of the axle/suspension system shown in FIG. 2;

FIG. 4 is a fragmentary schematic elevational view of a second exemplary embodiment axle/suspension system, according to the present invention, showing a reservoir operatively fluidly connected via a valve to an air spring mounted between the frame and one of the pair of suspension assemblies of the axle/suspension system;

FIG. 5 is a perspective view in section of the air spring of the axle/suspension system shown in FIG. 4;

FIG. 6 is an enlarged cross-sectional schematic view of the valve of the axle/suspension system shown in FIG. 4, showing the valve in a first position;

FIG. 7 is an enlarged cross-sectional schematic view of the valve of the axle/suspension system shown in FIGS. 4 and 6, showing the valve in a second position;

FIG. 8 is a fragmentary schematic elevational view of a third exemplary embodiment axle/suspension system, according to the present invention, showing a reservoir operatively fluidly connected via a valve to an air spring mounted between the frame and one of the pair of suspension assemblies of the axle/suspension system; and

FIG. 9 is a perspective view in section of the air spring of the axle/suspension system shown in FIG. 8.

Similar reference characters identify similar parts throughout.

### DESCRIPTION OF THE PREFERRED EMBODIMENT

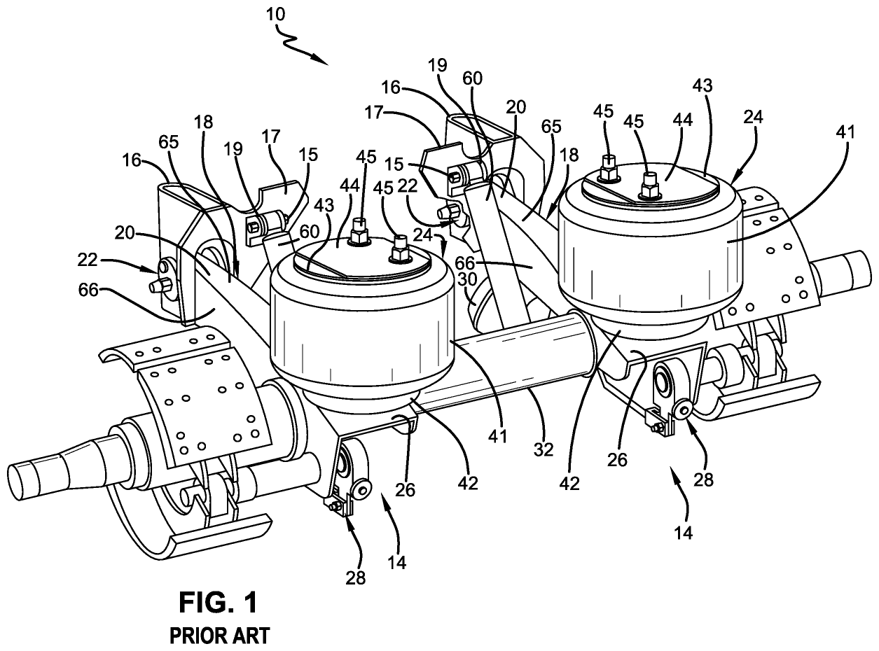

In order to better understand the environment in which the axle/suspension system for a heavy-duty vehicle of the present invention is utilized, a prior art passive axle/suspension system 10, incorporating a pair of prior art air springs 24, is shown in FIG. 1, and described in detail below.

It should be noted that axle/suspension system 10 typically includes a pair of mirror-image transversely-spaced suspension assemblies 14 mounted on a pair of longitudinally-extending spaced-apart main members (not shown) of a heavy-duty vehicle. Because suspension assemblies 14 are generally mirror-images of each other, for the sake of clarity and conciseness, only a single suspension assembly will be described below.

Suspension assembly 14 is pivotally connected to a hanger 16 by a beam 18. Beam 18 includes a pair of sidewalls 66 and a top plate 65 forming a generally upside-down integral U-shape, with the open portion of the beam facing generally downwardly. A bottom plate (not shown) extends between and is attached to the lowermost ends of sidewalls 66 by any suitable means, such as welds, to complete the structure of beam 18. Beam 18 includes a front end 20 having a bushing assembly 22 to facilitate pivotal connection of the beam to hanger 16, as is known. Beam 18 also includes a rear end 26, which is rigidly attached to a transversely-extending axle 32.

With continued reference to FIG. 1, suspension assembly 14 also includes air spring 24, mounted on and extending between beam rear end 26 and a respective one of the main members of the heavy-duty vehicle. Air spring 24 includes a bellows 41 and a piston 42. The top portion of bellows 41 is sealingly engaged with a bellows top plate 43. An air spring mounting plate 44 is mounted on top plate 43 by fasteners 45, which are also used to mount the top portion of air spring 24 to the main member of the heavy-duty vehicle. Piston 42 is generally cylindrical-shaped and has a generally flat bottom plate (not shown) and top plate (not shown). The bottom portion of the bellows 41 is sealingly engaged with the piston top plate, as is known. The piston bottom plate rests on beam top plate 65 at beam rear end 26 and is attached thereto in any suitable manner, such as by fasteners or bolts (not shown), as is known. A shock absorber 60 is mounted between an inboardly extending wing 17 of hanger 16, using a mounting bracket 19 and a fastener 15, and beam 18 (the mount not shown) in a well-known manner. For the sake of relative completeness, a brake system 28, including a brake chamber 30, is shown mounted on prior art suspension assembly 14.

Prior art axle/suspension system 10 is designed to absorb forces that act on the heavy-duty vehicle during operation. In particular, it is desirable for axle/suspension system 10 to be rigid or stiff in order to resist roll forces and thus provide roll stability for the heavy-duty vehicle. This is typically accomplished by using beam 18, which is rigid and also rigidly attached to axle 32. It is also desirable, however, for axle/suspension system 10 to be flexible to assist in cushioning the heavy-duty vehicle from vertical impacts and to provide compliance so that the axle/suspension system resists failure. Such flexibility is typically achieved through the pivotal connection of beam 18 to hanger 16 with bushing assembly 22. Air spring 24 cushions the ride for cargo and passengers while shock absorber 60 provides damping.

Prior art passive axle/suspension system 10, while adequately absorbing and/or reacting forces, has potential disadvantages, drawbacks, and limitations. Prior art axle/suspension system 10 requires shock absorber 60 to provide damping. However, shock absorber 60 is relatively heavy, which adds weight to axle/suspension system 10, thereby reducing the amount of cargo that can be carried by the heavy-duty vehicle. Shock absorbers 60 also add complexity to axle/suspension system 10 and are a service item that requires maintenance and/or replacement from time to time, thereby adding additional maintenance and/or replacement costs to the axle/suspension system.

In addition, prior art axle/suspension system 10 has an associated natural frequency that can potentially lead to the development and propagation of harmonic vibrations in and through the axle/suspension system. In particular, the natural frequency of prior art axle/suspension system 10 may lead to unwanted resonance even if critically damped by the shock absorber, which can potentially lead to tire resonant load variation resulting in irregular and/or excessive tire wear.

Irregular or excessive tire wear may potentially lead to increased tire maintenance and associated costs and/or reduced road safety due to an increased potential for uneven tire traction or tire failure. The axle/suspension system, according to the present invention, overcomes these disadvantages, drawbacks, and limitations.

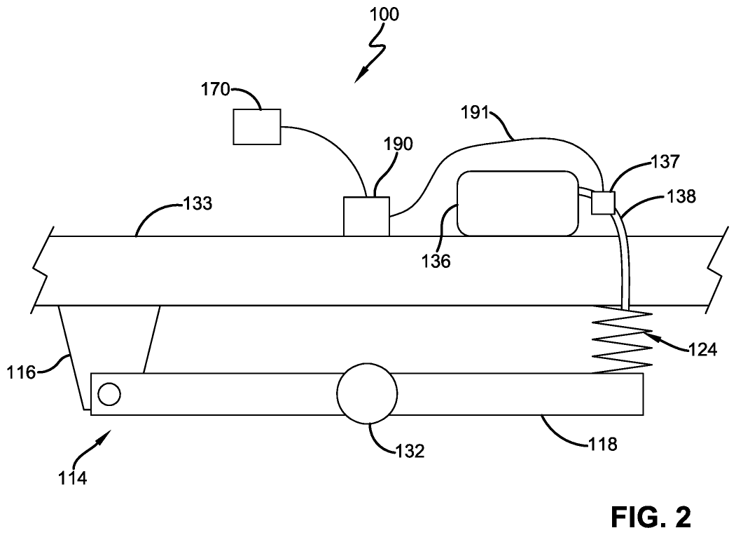

A first exemplary embodiment axle/suspension system 100 for heavy-duty vehicles, according to the present invention, is shown schematically in FIG. 2. Axle/suspension system 100 includes a pair of mirror-image suspension assemblies 114 (only one shown). Each suspension assembly 114 has an elongated beam 118, which extends longitudinally along the heavy-duty vehicle (not shown) and is pivotally connected at one of its ends to a hanger 116. Hanger 116 is attached to and depends from a main member 133 of the heavy-duty vehicle. An axle 132 extends transversely between, and is connected by some means to, beams 118 at a location from about the mid-point of each beam to the end of each beam opposite the pivotal connection. An air spring 124 is connected to, and extends between, beam 118 opposite the pivotal connection end of the beam and one of the main members 133.

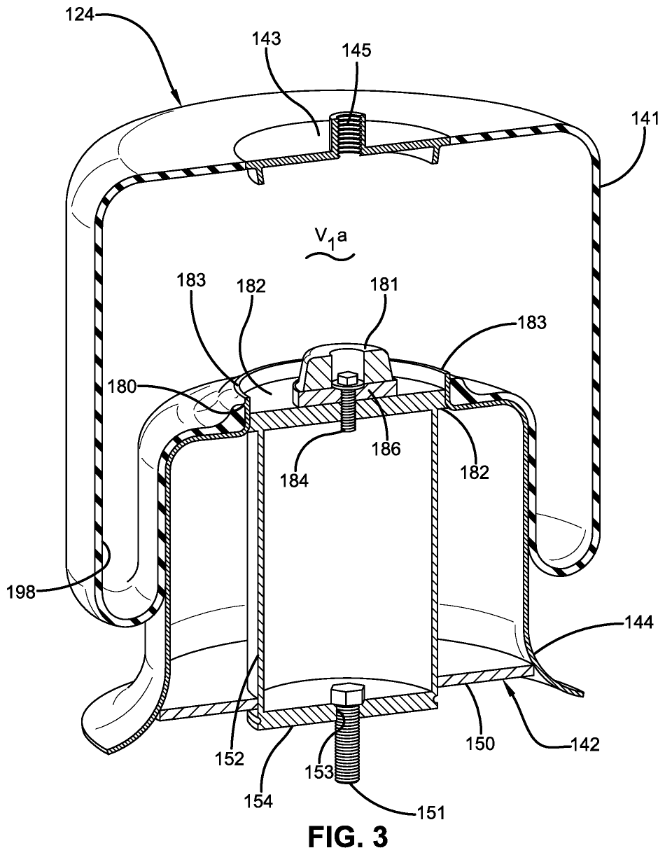

With particular reference to FIG. 3, air spring 124 includes a bellows 141 and a piston 142. The top portion of bellows 141 is sealingly engaged with a bellows top plate 143. An air spring mounting plate (not shown) is mounted on top plate 143 by fasteners (not shown), which are also used to mount the top portion of air spring 124 to main member 133 of the heavy-duty vehicle. Alternate means for mounting top plate 143 to main member 133, such as direct attachment by fasteners or welds, are also well known. Piston 142 is generally cylindrical-shaped and includes a continuous generally-stepped sidewall 144 attached to a generally flat bottom plate 150 and an integrally formed top plate 182. Bottom plate 150 is formed with an upwardly-extending central hub 152. Central hub 152 includes a bottom plate 154 formed with a central opening 153. A fastener 151 is disposed through opening 153 in order to attach piston 142 to the top of beam 118 at the beam rear end.

Top plate 182 of piston 142 is formed with a circular upwardly-extending protrusion 183 having a lip 180 formed about its circumference. Lip 180 cooperates with the lowermost end of bellows 141 to form an airtight seal between the bellows and the lip, as is known. Bellows 141, top plate 143, and piston top plate 182 define a bellows chamber 198 having an interior volume Via at design ride height. A bumper mounting plate 186 is mounted on piston top plate 182 by a fastener 184. A bumper 181 is rigidly attached to and extends upwardly from the top surface of bumper mounting plate 186, as is known. Bumper 181 serves as a cushion between piston top plate 182 and bellows top plate 143 to prevent contact between the plates, which can potentially cause damage during operation of the heavy-duty vehicle.

Bellows top plate 143 is formed with one or more openings 145. A fluid communication means or pathway 138 (FIG. 2), such as tubing or rigid channels, connects bellows chamber 198 of air spring 124 to a reservoir 136 through a control valve 137, allowing bellows chamber volume Via to selectively fluidly communicate with a volume within the reservoir. Openings 145 may also be in fluid communication with the external environment, such that pressure within the bellows chamber 198 may be selectively released from air spring 124. It is also contemplated that air spring 124 may be connected to a compressor or pump (not shown).

Reservoir 136 generally comprises a pressurized tank or chamber disposed adjacent to air spring 124. Alternatively, reservoir 136 may be centrally located an equal distance from a number of air springs 124 in a complex system. Reservoir 136 may be formed from any suitable material capable of withstanding mechanical strain, such as steel, as is known. Reservoir 136 may be a separate chamber connected or attached to one or more main members 133, cross braces (not shown), or other components of the heavy-duty vehicle. Alternatively, reservoir 136 may be incorporated into one or more main members 133, cross braces, or other components of the heavy-duty vehicle to conserve space.

Control valve 137 may be any valve or throttling component, or the like, that restricts, or throttles, air flow between components of axle/suspension system 100. In particular, control valve 137 is operatively connected to, or is disposed in-line with, and in fluid communication with, reservoir 136 and air spring 124. Control valve 137 may be placed between reservoir 136 and air spring 124 or incorporated into the reservoir or the air spring. More particularly, control valve 137 includes a continuously adjustable orifice (not shown). Alternatively, control valve 137 may be bidirectional and/or any suitable type of valve capable of providing variable reduction of airflow. In particular, the adjustable orifice of control valve 137 provides adjustment of airflow into or out of air spring 124, thereby providing adjustment of bellows chamber volume Via and thus the spring constant, or stiffness, of the air spring.

The adjustable orifice of control valve 137 is operatively connected to one or more electronic control units (ECUs) 190 by a conduit or line 191. One or more sensors 170 may be operatively connected to ECU 190. More specifically, sensor 170 may be disposed in or operatively connected to valve 137 and/or air spring 124 to detect a pressure, an air velocity or flow, and/or a ride height. Sensor 170 detects the state of, or changes in, pressure within, or in the height of, air spring 124 and generates signals that are transmitted to ECU 190. The state of, or changes in, air spring 124 detected by sensor 170 generally correspond to the vibration or frequency of motion of axle/suspension system 100. Thus, as pressure in air spring 124, level of ride height, or airflow through control valve 137 changes, the control valve may be activated to close or open in order to reduce or maintain bellows chamber volume Via and, thus, the spring constant, or stiffness, of the air spring. As a result, control valve 137 may alter or modify the natural frequency of axle/suspension system 100. It is also contemplated that control valve 137 may be a regulator-type valve tuned to close or open based on the pressure differential of air within reservoir 136 and air spring 124. Alternatively, the adjustable orifice of control valve 137 may be directly connected to sensor 170, such that signals generated by the sensor are transmitted directly to the control valve. In particular, control valve 137 may also comprise and/or be operatively connected to a separate air velocity sensor, or flow meter, (not shown) capable of measuring the velocity of air or flow rate passing through the adjustable orifice multiple times in a second. The flow meter may also be operatively connected to control unit 190.

During operation of the heavy-duty vehicle, sensor 170 generates various signals from air spring 124 and/or control valve 137 at multiple intervals within a short period of time. These signals generally correspond to the vibration or frequency of motion of the heavy-duty vehicle and axle/suspension system 100. The signals are transmitted to ECU 190, which uses complex algorithms to determine the frequency of motion of axle/suspension system 100. ECU 190 also determines whether adjustments to stiffness of air spring 124 need to be made in order to prevent the development and/or propagation of harmonic vibration in and through axle/suspension system 100, generating and transmitting a signal to control valve 137, accordingly. Alternatively, the signals from sensor 170 may be transmitted to control valve 137 to directly trigger the control valve to open or close. Upon receiving the signal from ECU 190 or, alternatively, sensor 170, control valve 137 opens or closes, allowing fluid communication through fluid communication pathway 138 between reservoir 136 and air spring 124. In the event fluid communication pathway 138 is closed, fluid communication between reservoir 136 and bellows chamber volume Via of air spring 124 is blocked, resulting in the bellows chamber volume remaining static or decreasing. In the event fluid communication pathway 138 is opened, fluid communication between reservoir 136 and bellows chamber volume Via of air spring 124 is allowed, such that the bellows chamber volume is increased. Thus, the opening and closing of control valve 137 changes the spring constant, or stiffness, of air spring 124, altering or modifying the stiffness or natural frequency of axle/suspension system 100 and smoothing the load variation of the tire, thereby reducing irregular or excessive tire wear. Thus, first exemplary embodiment axle/suspension system 100 has relatively less weight and complexity and dynamically alters the stiffness of air spring 124 and the stiffness or natural frequency of the axle/suspension system during operation of the heavy-duty vehicle to reduce irregular and/or excessive tire wear and increase the durability and safety of the axle/suspension system and its component parts.

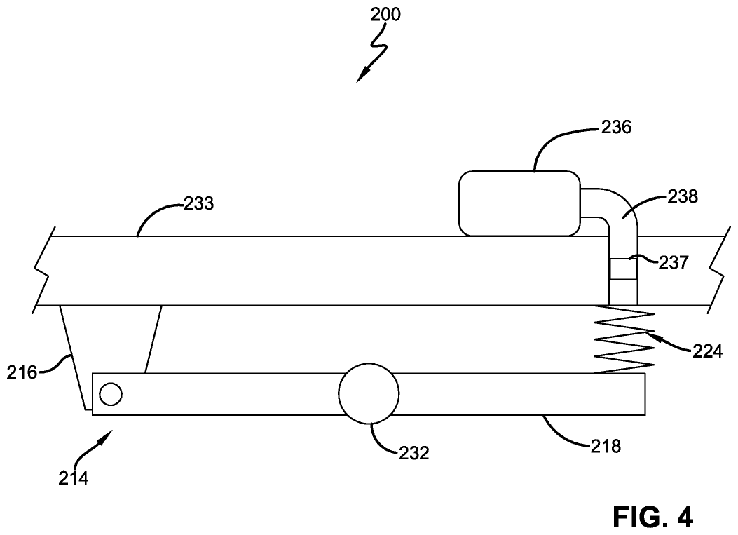

A second exemplary embodiment axle/suspension system 200 for heavy-duty vehicles, according to the present invention, is illustrated schematically in FIG. 4. Axle/suspension system 200 includes a pair of transversely-spaced suspension assemblies 214 (only one shown). Each suspension assembly 214 includes an elongated beam 218, which extends longitudinally along the heavy-duty vehicle (not shown) and is pivotally connected at one of its ends to a hanger 216. Hanger 216 is attached to and depends from a main member 233 of the heavy-duty vehicle. An axle 232 extends transversely between, and is connected by some means to, beams 218 at a location from about the mid-point of each beam to the end of each beam opposite the pivotal connection. An air spring 224 extends between, and is connected to, beam 218 opposite the pivotal connection end and a respective main member 233.

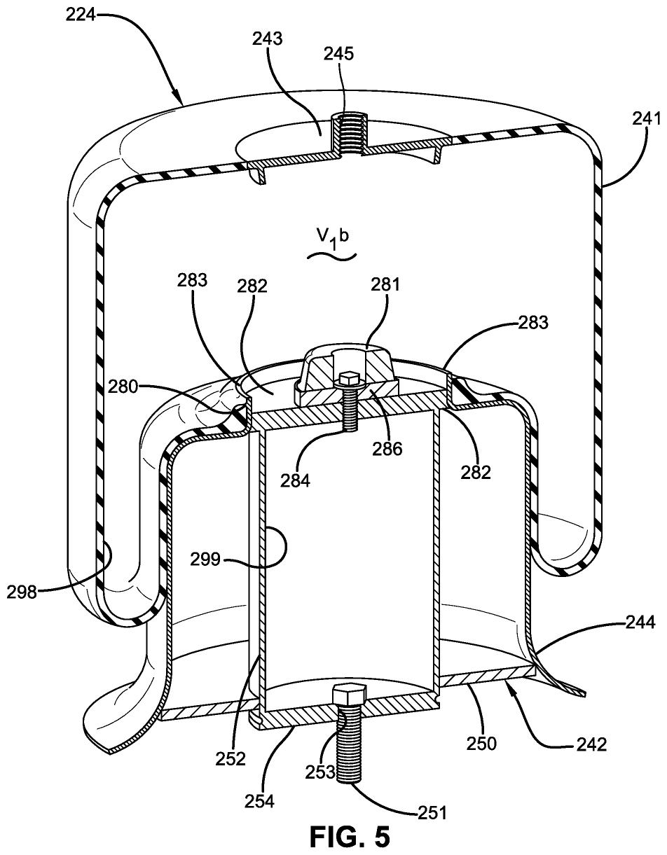

With particular reference to FIG. 5, air spring 224 includes a bellows 241 and a piston 242. The top portion of bellows 241 is sealingly engaged with a bellows top plate 243. An air spring mounting plate (not shown) is mounted on top plate 243 by fasteners (not shown), which are also used to mount the top portion of air spring 224 to main member 233 of the heavy-duty vehicle. Alternate means for mounting top plate 243 to main member 233, such as direct attachment by fasteners or welds, are also well known. Piston 242 is generally cylindrical-shaped and includes a continuous generally-stepped sidewall 244 attached to a generally flat bottom plate 250 and an integrally formed top plate 282. Bottom plate 250 is formed with an upwardly-extending central hub 252. Central hub 252 includes a bottom plate 254 formed with a central opening 253. A fastener 251 is disposed through opening 253 in order to attach piston 242 to the top of beam 218 at the beam rear end.

Top plate 282 of piston 242 is formed with a circular upwardly-extending protrusion 283 having a lip 280 formed about its circumference. Lip 280 cooperates with the lowermost end of bellows 241 to form an airtight seal between the bellows and the lip, as is known. Bellows 241, top plate 243, and piston top plate 282 define a bellows chamber 298 having an interior volume V₁b at design ride height. A bumper mounting plate 286 is mounted on piston top plate 282 by a fastener 284. A bumper 281 is rigidly attached to, and extends upwardly from the top surface of, bumper mounting plate 286, as is known. Bumper 281 serves as a cushion between piston top plate 282 and bellows top plate 243 to prevent contact between the plates, which can potentially cause damage during operation of the heavy-duty vehicle.

Bellows top plate 243 is formed with one or more openings 245. A fluid communication means or pathway 238, such as tubing or rigid channels, connects openings 245, allowing fluid communication between bellows chamber 298 of air spring 224 and a reservoir 236 through a control valve 237. Thus, bellows chamber volume V₁b fluidly communicates with a volume within reservoir 236. Air spring 224 may also be connected to a compressor or pump (not shown). Openings 245 may also be open to the external environment to allow fluid communication between bellows chamber volume V₁b and the external environment, such that pressure within the bellows chamber 298 may be selectively released from air spring 224. It is also contemplated that air spring 224 may be directly connected to reservoir 236 through openings 245.

Reservoir 236 comprises a pressurized tank or chamber disposed adjacent to air spring 224. Alternatively, reservoir 236 may be centrally located an equal distance from a number of air springs 224 in a complex system. Reservoir 236 may be formed from any suitable material capable of withstanding mechanical strain, such as steel, as is known. Reservoir 236 may be a separate chamber connected or attached to one or more main members 233, cross braces (not shown), or other components of the heavy-duty vehicle. Alternatively, reservoir 236 may be incorporated into one or more main members 233, cross braces, or other components of the heavy-duty vehicle to conserve space.

Control valve 237 may be disposed between reservoir 236 and air spring 224 in fluid communication pathway 238 or may be incorporated into the reservoir or air spring. More specifically, control valve 237 may be placed in the bellows top plate 243 of air spring 224, between bellows chamber 298 and reservoir 236, or in piston top plate 282, between the bellows chamber and a piston chamber 299. Control valve 237 provides selective fluid communication between reservoir 236 and air spring 224 or, alternatively, between bellows chamber 298 and a piston chamber 299. Control valve 237 also operates as a sensor capable of detecting the frequency of motion of axle/suspension system 200. It should be understood that control valve 237 may be any valve or throttling component, or the like, that restricts, or throttles, air flow between components of axle/suspension system 200. In particular, control valve 237 is a normally-closed valve that is mechanically sensitive and responds to a chosen frequency of motion of axle/suspension system 200. More particularly, control valve 237 has a limited frequency sensitivity or response range such that the control valve is not sensitive to or does not respond to frequencies of axle/suspension system 200 outside the chosen range. Control valve 237 is designed to be sensitive and respond to a frequency of axle/suspension system 200 of about 10 hertz and cease being sensitive and responsive once the frequency reaches about 9 hertz or below and 11 hertz or above. Thus, control valve 237 is only responsive to the frequency of axle/suspension system 200 in the range of from about 9 hertz to about 11 hertz.

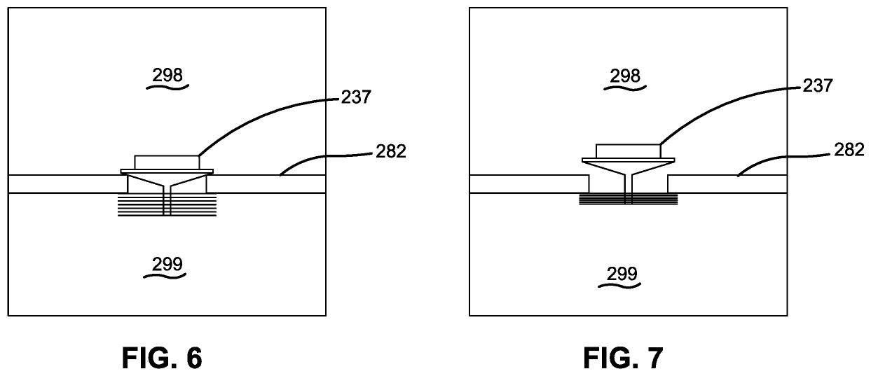

With particular reference to FIGS. 6-7, during operation of the heavy-duty vehicle, axle/suspension system 200 vibrates at a frequency that may be altered by environmental factors, such as road conditions, and/or the speed of the heavy-duty vehicle. Once the frequency of axle/suspension system 200 is equal to the selected frequency of control valve 237, the control valve moves from a first, or normally closed, position (FIG. 6) to a second, or open, position (FIG. 7). In the second, or open, position, control valve 237 allows fluid communication between reservoir 236 and air spring 224, which increases bellows chamber volume V₁b, altering the spring rate, or stiffness, of the air spring, thereby modifying or adjusting the stiffness or natural frequency of axle/suspension system 200 and smoothing the load variation of the tire to eliminate irregular or excessive tire wear. As the stiffness or frequency of axle/suspension system 200 increases or decreases outside the chosen frequency range, control valve 237 returns to the first, or closed, position.

It is also contemplated that control valve 237 may be a normally-open valve such that, when the frequency of axle/suspension system 200 is equivalent to the selected frequency of the control valve, the control valve moves to a second, or closed, position, preventing or inhibiting fluid communication between reservoir 236 and air spring 224. Once fluid communication between reservoir 236 and air spring 224 is inhibited, bellows chamber volume V₁b remains static or decreases, altering the spring constant, or stiffness, of the air spring, thereby modifying or adjusting the stiffness or natural frequency of axle/suspension system 200. As the stiffness or frequency of motion of axle/suspension system 200 increases or decreases outside the chosen resonant frequency range, control valve 237 returns to the first, or open, position. Thus, axle/suspension system 200 has relatively less weight and complexity and dynamically alters the stiffness of air spring 224 and the stiffness or natural frequency of the axle/suspension system during operation of the heavy-duty vehicle to reduce irregular or excessive tire wear and increase the durability and safety of the axle/suspension system and its component parts.

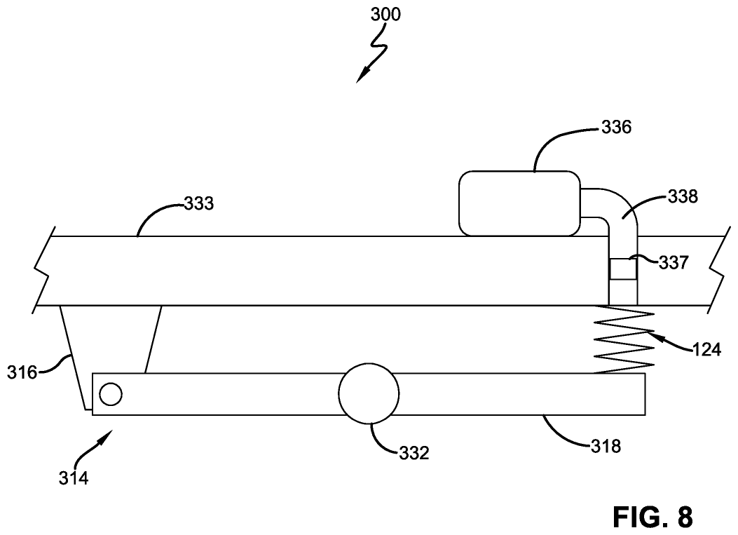

A third exemplary embodiment axle/suspension system 300 for heavy-duty vehicles of the present invention is shown schematically in FIG. 8. Axle/suspension system 300 includes a pair of transversely spaced suspension assemblies 314 (only one shown). Each suspension assembly includes an elongated beam 318, which extends longitudinally along a heavy-duty vehicle (not shown) and is pivotally connected at one of its ends to a hanger 316. Hanger 316 is attached to and depends from a main member 333 of the heavy-duty vehicle. An axle 332 extends transversely between, and is connected by some means to, beams 318 at a location from about the mid-point of each beam to the end of each beam opposite the pivotal connection. An air spring 324 extends between, and is connected to, beam 318 opposite the pivotal connection end and a respective main member 333.

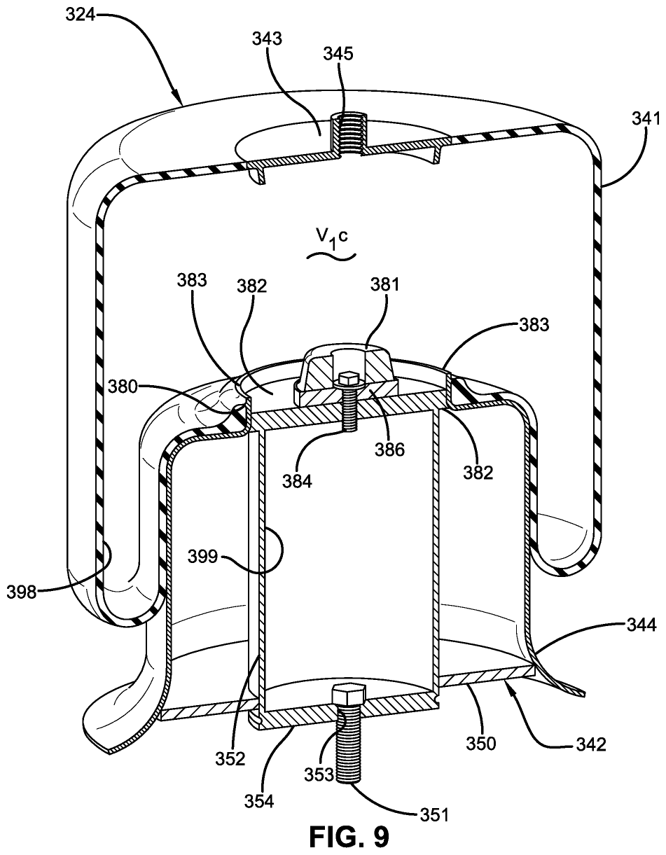

With particular reference to FIG. 9, air spring 324 includes a bellows 341 and a piston 342. The top portion of bellows 341 is sealingly engaged with a bellows top plate 343. An air spring mounting plate (not shown) is mounted on top plate 343 by fasteners (not shown), which are also used to mount the top portion of air spring 324 to main member 333 of the heavy-duty vehicle. Alternate means for mounting top plate 343 to main member 333, such as direct attachment by fasteners or welds, are also well known. Piston 342 is generally cylindrical-shaped and includes a continuous generally stepped sidewall 344 attached to a generally flat bottom plate 350 and an integrally formed top plate 382. Bottom plate 350 is formed with an upwardly-extending central hub 352. Central hub 352 includes a bottom plate 354 formed with a central opening 353. A fastener 351 is disposed through opening 353 in order to attach piston 342 to the top of beam 318 at the beam rear end.

Top plate 382 of piston 342 is formed with a circular upwardly-extending protrusion 383 having a lip 380 formed about its circumference. Lip 380 cooperates with the lowermost end of bellows 341 to form an airtight seal between the bellows and the lip, as is known. Bellows 341, top plate 343, and piston top plate 382 define a bellows chamber 398 having an interior volume Vic at design ride height. A bumper mounting plate 386 is mounted on piston top plate 382 by a fastener 384. A bumper 381 is rigidly attached to, and extends upwardly from the top surface of, bumper mounting plate 386, as is known. Bumper 381 serves as a cushion between piston top plate 382 and bellows top plate 343 to prevent contact between the plates, which can potentially cause damage during operation of the heavy-duty vehicle.

Bellows top plate 343 is formed with one or more openings 345. A fluid communication means or pathway 338, such as tubing or rigid channels, is connected to openings 345 and provides fluid communication between bellows chamber 398 and a reservoir 336 through a control valve 337, allowing bellows chamber volume Vic to communicate with a volume within the reservoir. Openings 345 may also be in fluid communication with the external environment such that pressure within bellows chamber 398 may be selectively released from air spring 324. Air spring 324 may also be connected to a compressor or pump (not shown).

Reservoir 336 comprises a pressurized tank or chamber disposed adjacent to air spring 324. Alternatively, reservoir 336 may be centrally located an equal distance from a number of air springs 324 in a complex system. Reservoir 336 may be formed from any suitable material capable of withstanding mechanical strain, such as steel, as is known. Reservoir 336 may be a separate chamber connected or attached to one or more main members 333, cross braces (not shown), or other components of the heavy-duty vehicle. Alternatively, reservoir 336 may be incorporated into one or more main members 333, cross braces, or other components of the heavy-duty vehicle to conserve space.

Control valve 337 may be any valve or throttling component, or the like, that restricts, or throttles, air flow between components of axle/suspension system 300. In particular, control valve 337 may be disposed between reservoir 336 and air spring 324 within fluid communication pathway 338 or may be incorporated into the reservoir or the air spring to provide selective fluid communication between the reservoir and the air spring. More particularly, control valve 337 may be placed in bellows top plate 343, between bellows chamber 398 and reservoir 336, or in piston top plate 382 between the bellows chamber and a piston chamber 399. Control valve 337 operates as a sensor to detect the frequency of motion of axle/suspension system 300 and includes a sprung mass (not shown) or displaceable element (not shown) disposed within a passage (not shown). In particular, the passage has a central portion with a dimension that is generally larger than the sprung mass or displaceable element and has tapered portions at both ends that have respective dimensions that are generally smaller than the sprung mass or displaceable element. The sprung mass or displaceable element is disposed within the central portion and away from the tapered portions of the passage in a neutral position. The sprung mass or displaceable element is mechanically sensitive or moves in response to a selected range of frequencies of axle/suspension system 300. More particularly, depending upon the precise frequency of axle/suspension system 300, the sprung mass or displaceable element vibrates axially or along the passage, alternately approaching, or becoming disposed within, the tapered portions of the passage and causing restriction of air flow through valve 337.

During operation of the heavy-duty vehicle, axle/suspension system 300 vibrates at a frequency that may be altered by environmental factors, such as road conditions, and/or the speed of the heavy-duty vehicle. Once the frequency of motion of axle/suspension system 300 is equivalent to a frequency within the selected frequency range of control valve 337, the sprung mass or displaceable element within the control valve moves axially or along the passage, approaching, or becoming disposed within, the tapered portions and restricting air flow through the control valve, thereby restricting fluid communication in fluid communication pathway 338 between reservoir 336 and air spring 324. Restriction of fluid communication between reservoir 336 and air spring 324 decreases bellows chamber volume Vic, changing the spring constant, or stiffness, of the air spring, thereby modifying or adjusting the stiffness or natural frequency of axle/suspension system 300 and smoothing the load variation of the tire to eliminate irregular or excessive tire wear. As the frequency of motion of axle/suspension system 300 increases or decreases outside the selected frequency range, the sprung mass or displaceable element within control valve 337 returns to a neutral position within the central portion and away from the tapered portions of the passage, allowing fluid communication between the reservoir 336 and air spring 324. Thus, axle/suspension system 300 has relatively less weight and complexity and dynamically alters the stiffness of air spring 324 and the stiffness or natural frequency of the axle/suspension system during operation of the heavy-duty vehicle to reduce irregular or excessive tire wear and increase the durability and safety of the axle/suspension system and its component parts.

It is understood that exemplary embodiment axle/suspension systems 100, 200, 300, according to the present invention, could utilize one or more sensors to detect a condition of the heavy-duty vehicle, including a tire pressure, a ride height, a wheel speed, a steering angle, an acceleration, a pressure within a heavy-duty vehicle component, a force acting upon or between heavy-duty vehicle components, a fluid flow within a heavy-duty vehicle component, or a natural frequency of a heavy-duty vehicle component. It is also understood that exemplary embodiment axle/suspension systems 100, 200, 300, according to the present invention, could be utilized on all types of axle/suspension systems without changing the overall concept or operation of the present invention. It is further understood that axle/suspension systems 100, 200, 300 may employ other types and/or arrangements of reservoirs, conduits, valves, electronic or mechanical sensors, electronic computing units, and the like without changing the overall concept or operation of the present invention.

Accordingly, improved axle/suspension systems 100, 200, 300, according to the present invention are simplified; provide an effective, safe, inexpensive, and efficient structure and method that achieve all the enumerated objectives; provide for eliminating difficulties encountered with prior axle/suspension systems; and solve problems and obtain new results in the art. In the foregoing description, certain terms have been used for brevity, clarity, and understanding, but no unnecessary limitations are to be implied therefrom beyond the requirements of the prior art because such terms are used for descriptive purposes and are intended to be broadly construed. Moreover, the description and illustration of the invention is by way of example, and the scope of the invention is not limited to the exact details shown or described.

Having now described the features, discoveries and principles of the invention; the manner in which the axle/suspension system is used and installed; the characteristics of the construction, arrangement, and method steps; and the advantageous, new, and useful results obtained, the new and useful structures, devices, elements, arrangements, process, parts, and combinations are set forth in the appended claims.

What is claimed is:

1. An axle/suspension system for a heavy-duty vehicle comprising:
a wheel;
a sensor operatively connected to an air spring, said sensor being capable of detecting a condition of a road or a condition of said heavy-duty vehicle; and
said air spring being mounted on the axle/suspension system and having a stiffness capable of being altered in response to the sensor to reduce resonant load variation on said wheel.

2. The axle/suspension system for a heavy-duty vehicle of claim 1, said one or more sensing means generating a signal indicative of the resonant frequency of said axle/suspension system.

3. The axle/suspension system for a heavy-duty vehicle of claim 2, said condition of said heavy-duty vehicle being selected from the group consisting of a pressure within a component of the heavy-duty vehicle and a frequency of motion of said component of said heavy-duty vehicle.

4. The axle/suspension system for a heavy-duty vehicle of claim 2, said condition of said heavy-duty vehicle being selected from the group consisting of a tire pressure, a ride height, a wheel speed, a steering angle, an acceleration of said heavy-duty vehicle, a force acting upon or between a component of the heavy-duty vehicle, a pressure within said component, and a fluid flow within the component.

5. The axle/suspension system for a heavy-duty vehicle of claim 3, said air spring further comprising a volume in fluid communication with a reservoir.

6. The axle/suspension system for a heavy-duty vehicle of claim 5, said air spring further comprising a pump in fluid communication with the air spring and said reservoir and operatively connected to said sensor.

7. The axle/suspension system for a heavy-duty vehicle of claim 6, said air spring further comprising a valve disposed between and in fluid communication with said reservoir and said air spring and operatively connected to said sensor;
wherein said valve is capable of maintaining and adjusting said volume of the air spring.

8. The axle/suspension system for a heavy-duty vehicle of claim 7, said valve being operatively connected to said air spring and said reservoir by a fluid communication pathway disposed between the air spring and the reservoir.

9. The axle/suspension system for a heavy-duty vehicle of claim 8, said valve selectively controlling a fluid flow through said fluid communication pathway in response to said sensor.

10. The axle/suspension system for a heavy-duty vehicle of claim 9, said valve selectively controls said fluid flow through said fluid communication pathway in response to said sensor to cause at least one of said reservoir and said air spring to reduce said volume of the air spring.
